(19) United States
(12) Patent Application Publication
(10) Pub. No.: US 2003/0236703 A1
(43) Pub. Date: Dec. 25, 2003

(54) Advertising planter method for hotel rooms

(76) Inventors: Irena Baranova, Saint Petersburg, FL (US); Craig Van Pelt, Saint Petersburg, FL (US)

Correspondence Address: STEPHEN E. FELDMAN, P.C., 12 East 41st Street, New York, NY, 10017, US

(21) Appl. No.: 10/178,671

(22) Filed: Jun. 24, 2002

(51) Int. Cl. G06F 17/60

(52) U.S. Cl. 705/14; 705/1

(57) ABSTRACT

The present invention is directed toward a method of doing business that provides for the floral decorating of a hotel room. The present invention describes a method for providing planters and plants to hotel rooms and guest rooms free of charge. Advertisers pay for advertising space on the planters, and the advertisements are then printed upon or affixed to the sides of the planters. The plants are planted in a soil substitute which lowers the all-around maintenance needs (watering, fertilizer, repotting) of the plants/flowers, ensuring a longer lasting display.

### FIELD OF THE INVENTION

The present invention is directed toward a business method that provides for the use of a potted plant for a hotel room, said pot or planter being outfitted with advertisements. In particular, the invention concerns a receptacle for a plant (planter) in which the outside surface or surfaces of the planter either have advertisements affixed to or printed upon them. The planters/plants are then placed in hotels (in guest rooms) or other businesses for the dual purposes of decoration and advertising.

### BACKGROUND OF THE INVENTION

People like plants, and plants offer people a way to inexpensively and uniquely decorate the spaces in which they live, work, play, and stay. Holders for plants come in every imaginable shape and size, and are purchased for a variety of reasons, including beauty, size, and convenience. While planters bought for permanent use in the home may be made of such solid materials as pottery, glass, or metal, the need has often arisen for a lighter, more mobile planter that may be used to efficiently transport the plant without damaging it.

Planters have been created to fulfill different, specific functions, such as protection of the plant during transport. U.S. Pat. No. 5,427,240 to Holtkamp, Jr., shows a shipping box for plants in which multiple holder panels are positioned within a box so that plants may be stored securely in rows for transport. A similar U.S. Pat. No. 5,875,904 to Vorstenbosch shows a box-like transport container for plants. This container has at least one partially opened side, and a flexible covering, which allow plants to be safely and easily transported. Both these patents allow for the transportation of multiple plants that have been potted in a variety of planters.

Individual plant packaging with an eye toward the simultaneous protection and display of the plant has also been contemplated in several patents. U.S. Pat. No. 4,014,134 to Womack, Jr. shows a plant package featuring a transparent member embedded in a card which is positioned over the plant yet allows the plant's foliage to be displayed. U.S. Pat. No. 4,124,953 to Patton shows a planter kit and display package consisting of a planter, a transparent cover, and a “dry, compressed, growing medium” in the planter in place of soil. This kit provides the dual function of protection for and display of the plant.

U.S. Pat. No. 3,707,806 to Toews et. al. shows a container and handle arrangement for the transport of plants in which two containers for plants are separated by a handle. This handle extends upward from between the containers, making it easy for the carrier to ensure smooth handling of the container. The handle, being a flat surface, may also bear an advertisement for, for example, the store in which the plant/container was purchased.

U.S. Pat. No. 6,041,546 to Baranova describes a planter pouch comprising a bag shaped, flexible plastic bladder containing a polymeric growth. This patent is assigned to the present assignee and the polymeric growth material is utilized in the present invention. Use of the polymeric growth allows the plants in the advertising planters to remain without water for a longer time, and prevents unnecessary spillage or leakage of dirt.

A previous patent of the current applicant described a method in which the above described planter pouches were hung en masse in selected hotel rooms. The plants created exotic and calming environments in the hotel rooms without taking up valuable furniture surface or floor space. The guests who preferred to stay in such an outfitted room paid higher rates than those of a “regular” room.

The prior art, however, does not anticipate the particular needs of advertisers in this day and age. The present invention seeks to provide an efficient, inexpensive, planter that may be distributed free of charge to hotels and other businesses, and which may be used as a mini-billboard for advertisements. The cost of the plant/planter would be covered by the advertising fees paid by the companies who buy space on the planter for their advertisements. The primary function of this planter would be to serve as a receptacle for a plant (including a potentially flowering plant or even simply flowers) while simultaneously providing advertising space for the sponsors.

### SUMMARY OF THE INVENTION

The present invention provides a planter made of a material such as cardboard, light wood, plastic, or some other material of a reasonable weight. The planter contains a plant of any type or flowers planted in polymeric growth, a soil substitute which retains water longer (thus eliminating the need for frequent watering), and will not spill or stain as soil often does. Advertisements are either affixed to or printed upon the sides of the planter. The planter and plant are supplied to a hotel (for placement in guest rooms) or other businesses free of charge. The advertisers pay money for the advertisements to the company that supplies the planter and plant to the hotel rooms.

### BRIEF DESCRIPTION OF THE DRAWINGS

FIG. 1 illustrates a side view of the advertising planter, plant, and advertisements.

FIG. 2 illustrates the other side view of the advertising planter, plant, and advertisements, visible when the planter is rotated 180 degrees.

FIG. 3 illustrates a plan view of the advertising planter and plant.

FIG. 4 illustrates a view of the planter in a hotel room.

FIG. 5 is a flow chart showing the method of this invention.

### DETAILED DESCRIPTION OF THE INVENTION

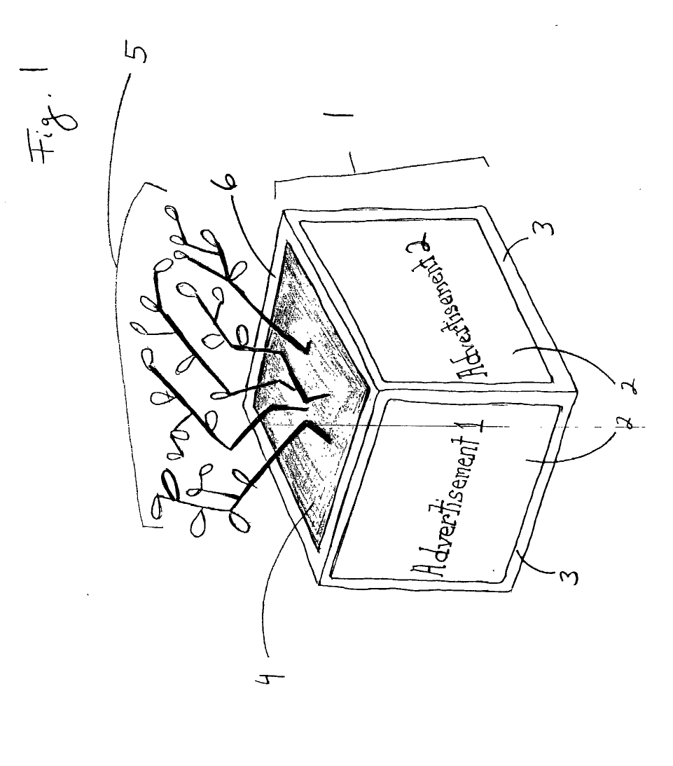

Each of FIGS. 1 through 3 shows a perspective of the advertising planter and plant. Although the planter shown in these figures has a box-like shape, it may be embodied in another shape such as a pyramid, a sphere with a base, or any other shape upon which advertisements may be affixed.

FIG. 1 shows sides 3 of the planter 1. The planter may be made from reinforced cardboard, light wood, plastic, or any material which will contain the plant 5 and planting material 4 and allow advertisements 2 to be affixed to the planter. The advertisements 2 may be affixed by any means such as by glue or by metal fasteners, or the advertisements may be printed on the container material itself. Planting material 4 is placed into the planter 1. A lip or edge 6 runs along the top of the container 1 and assists with containment of the planting material 4. Planting material 4 supports at least one plant 5. The plant 5 may be a plant or flowering plant of any type desired by either the advertisers or the hotel administration. A bouquet of flowers may also be “planted” in the planter if preferred.

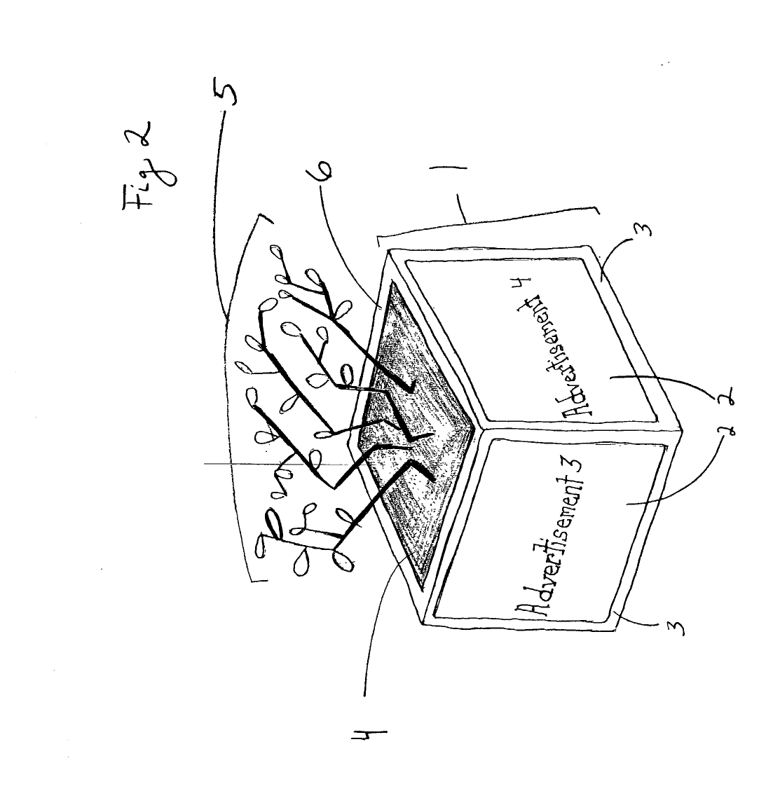

FIG. 2 shows the same perspective of planter 1, but with the planter 1 turned 180 degrees, thus making further advertisements 2 visible. Ideally, all sides 3 or surfaces of the planter 1 are used to hold advertisements 3. Again, at least one plant 5 is planted in the planting material 4 contained within the container 1. Here, too, the lip or edge 6 runs along the top of the container 1 and assists with containment of the planting material 4.

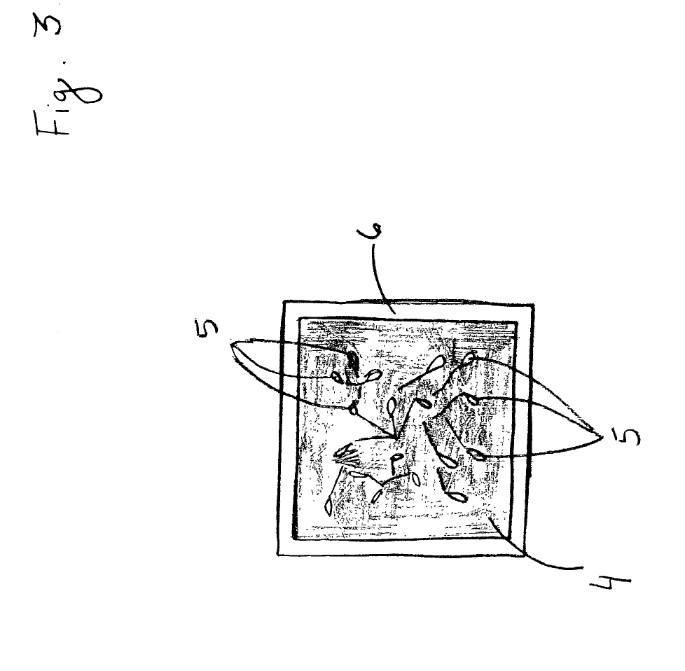

FIG. 3 shows a bird's eye view of the planter 1, in which the lip or edge 6 is visible. Within the lip or edge 6 is contained the planting material 4, and at least one plant 5. The advertisements 2 are not visible in this perspective.

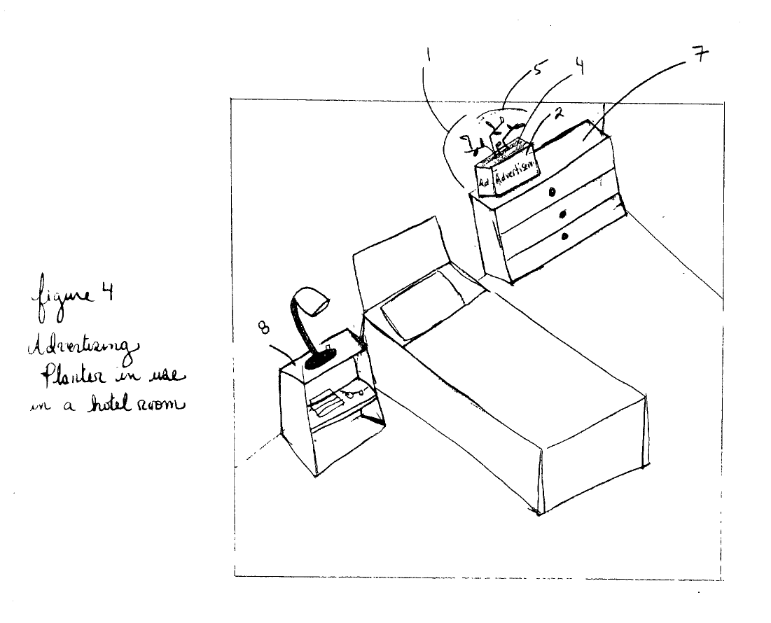

FIG. 4 illustrates the advertising planter 1 as it may be used in a hotel room. The planter 1 may be placed upon a surface such as the top of a dresser 7. The planter 1 might also be placed on top of another table such as a bedside table 8, or hung from the ceiling or placed on the floor. When placed in any of these locations, the advertisements 2 are visible to the hotel guest from almost any area of the hotel room.

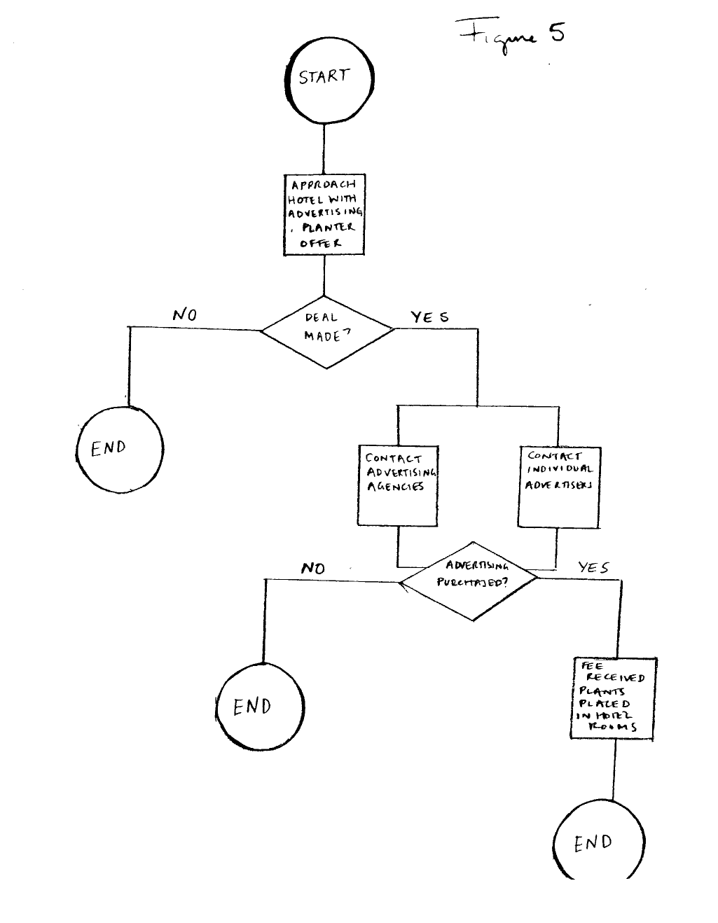

FIG. 5 is flow chart showing the method of this invention. The outside company begins the process by contacting a variety of advertising agencies who find clients who wish to purchase advertising space on the planter. The company may also contact clients independently of the advertising agency. The company charges advertisers predetermined fees which vary depending on the number of advertisements and the amount of space/number of planters desired. The advertisements are then printed on the sides of the planter itself, or affixed to the sides of a pre-existing planter. A plant or flowers will be selected and potted, and the plant and planter will be placed in a hotel room. The hotel pays no fee for this service. The cost of the plant, planter, and placement is paid by the advertisers.

Additional variations of the inventive planter are also possible and contemplated that will fall within the spirit and scope this invention as further defined by the claims that follow.

What is claimed is:

1. The method of providing plants to a hotel or guest room by an independent company comprising:
a. Providing plants in planters to the hotel or guest rooms.
b. Charging advertisers for advertising space on the planters.
c. Printing or affixing advertisements onto planters.

2. The method of claim 1 wherein the capitalization and operation of the method is done by an independent company.

3. The method of claim 1 wherein a polymeric growth material is used for planting in place of soil.

4. The method of claim 1 wherein said planter is constructed of a lightweight material.

5. The method of claim 1 wherein said plant may be a plant, flowering plant, or floral arrangement of any type.

6. The method of claim 1 wherein flowers or plants can be used to decorate said room.

7. The method of claim 1 wherein said potential advertisers are contacted via an advertising agency.

8. The method of claim 1, wherein said potential advertisers are contacted individually by said independent company.
